(19) United States
(12) Patent Application Publication
(10) Pub. No.: US 2011/0050133 A1
(43) Pub. Date: Mar. 3, 2011

(54) LED Lamps with Packaging as a Kit

(75) Inventors: Zdenko Grajcar, Crystal, MN (US); Brian Babb, Minneapolis, MN (US)

(73) Assignee: ONCE INNOVATIONS, INC., Plymouth, MN (US)

(21) Appl. No.: 12/871,894

(22) Filed: Aug. 30, 2010

Related U.S. Application Data
(60) Provisional application No. 61/237,686, filed on Aug. 28, 2009.

(51) Int. Cl. H05B 37/02; H01J 5/02; H01J 9/50

(52) U.S. Cl. 315/307; 313/317; 445/2

(57) ABSTRACT

Apparatus and methods for re-usable packaging of a lighting product include providing a container body to receive an electric lamp and a cover that can be repeatedly sealed and unsealed to the container. In an illustrative example, the lamp may be an AC LED lamp substantially located within the container body by a lamp locating feature on a bottom interior surface of the container body. In some embodiments, an interior surface of the lid may provide a projecting feature configured to positively retain the lamp in the lamp locating feature when the lid is installed on the container body. In various embodiments, the container body and the container lid may advantageously provide a protective package that may be sold as a kit, and may further provide a durable and reusable general purpose container system that may, for example, substantially reduce an environmental footprint associated with lamp packaging.

### CROSS-REFERENCE TO RELATED APPLICATIONS

This application claims priority to U.S. Ser. No. 61/237,686, entitled “LED Lamps with Packaging as a Kit,” filed by Grajcar, et al. on Aug. 28, 2009, the entire contents of which are incorporated herein by reference.

### TECHNICAL FIELD

Various embodiments relate generally to lighting systems that include light emitting diodes (LEDs), and some embodiments relate to LED lamp packaging.

### BACKGROUND

LEDs are widely used device capable of illumination when supplied with current. Typically, an LED is formed as a semiconductor diode having an anode and a cathode. In theory, an ideal diode will only conduct current in one direction. When sufficient forward bias voltage is applied between the anode and cathode, conventional current flows through the diode. Forward current flow through an LED may cause photons to recombine with holes to release energy in the form of light.

The emitted light from some LEDs is in the visible wavelength spectrum. By proper selection of semiconductor materials, individual LEDs can be constructed to emit certain colors (e.g., wavelength), such as red, blue, or green, for example.

In general, an LED may be created on a conventional semiconductor die. An individual LED may be integrated with other circuitry on the same die, or packaged as a discrete single component. Typically, the package that contains the LED semiconductor element will include a transparent window to permit the light to escape from the package.

### SUMMARY

Apparatus and methods for re-usable packaging of a lighting product include providing a container body to receive an electric lamp and a cover that can be repeatedly sealed and unsealed to the container. In an illustrative example, the lamp may be an AC LED lamp substantially located within the container body by a lamp locating feature on a bottom interior surface of the container body. In some embodiments, an interior surface of the lid may provide a projecting feature configured to positively retain the lamp in the lamp locating feature when the lid is installed on the container body. In various embodiments, the container body and the container lid may advantageously provide a protective package that may be sold as a kit, and may further provide a durable and reusable general purpose container system that may, for example, substantially reduce an environmental footprint associated with lamp packaging.

In some examples, apparatus and associated methods may involve an LED lamp assembly, alone or in a reusable package as a kit. In an illustrative example, a re-usable container with a screw-on lid may contain an LED lamp. In some examples, the container may be transparent and permit visual inspection of the LED lamp assembly from 360 degrees in a plane. The container may, in some examples, be formed substantially primarily from recycled materials. Various embodiments of the container may be stackable with similar containers for ready display on a retail shelf, for example.

Various embodiments may achieve one or more advantages. For example, some embodiments may substantially reduce cost, size, component count, weight, and/or improve reliability of a LED packaged for retail sale. Various embodiments may achieve significant reductions in carbon footprint and waste stream, hazardous chemical use, and/or life cycle energy consumption. For example, packaging may be readily re-used as a container for a wide variety of small items. In some examples, one or more components of a packaged kit may be substantially biodegradable.

In some embodiments, an LED lamp may be advantageously constructed for improved thermal management performance and features, reduced manufacturing complexity and cost, and/or reduced component count. In particular examples, and without limitation, an LED lamp may be in a GU 10 or a PAR 30 form factor.

The details of various embodiments are set forth in the accompanying drawings and the description below. Other features and advantages will be apparent from the description and drawings, and from the claims.

### BRIEF DESCRIPTION OF THE DRAWINGS

FIGS. 1-9 depict construction and arrangement of an exemplary LED lamp in a GU 10 form factor.

FIGS. 10-13 depict exemplary packaging and an LED lamp in GU 10 form factor arranged as a kit.

FIGS. 14-20 depict construction and arrangement of an exemplary LED lamp in a PAR 30 form factor.

FIGS. 21-24 depict exemplary packaging and an LED lamp in PAR 30 form factor arranged as a kit.

Like reference symbols in the various drawings indicate like elements.

### DETAILED DESCRIPTION OF ILLUSTRATIVE EMBODIMENTS

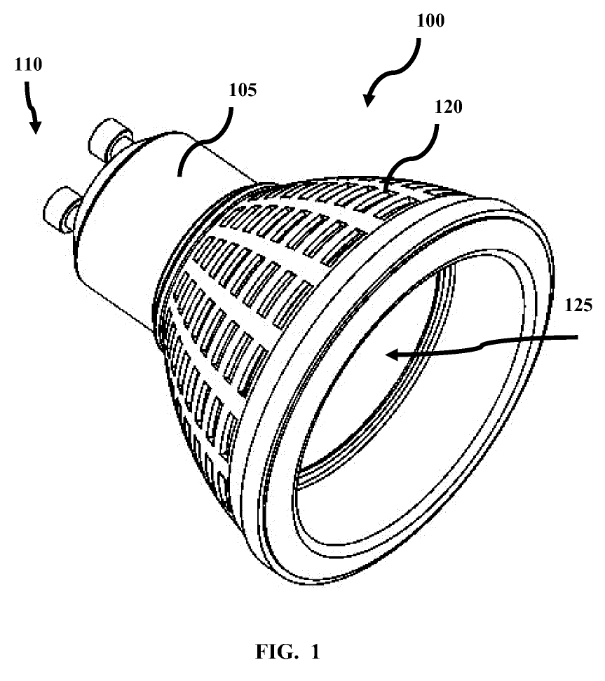

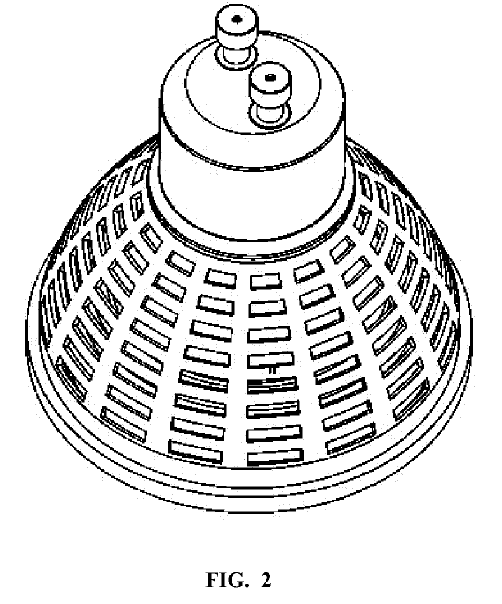

FIGS. 1-9 depict construction and arrangement of an exemplary LED lamp in a GU 10 form factor. FIGS. 1-2 show perspective views of an exemplary LED lamp 100. The lamp 100 includes a base 105, a pair of terminals 110, a body 120, and a lens 125. The body 120 and the lens 125 define a light chamber in which an LED may be disposed. When the pair of terminals are coupled to an electric power source (e.g., AC, DC voltage or current), the LED may respond by generating light. A reflector in the body 120 may generally direct the light from the LED substantially outward from the lens 125.

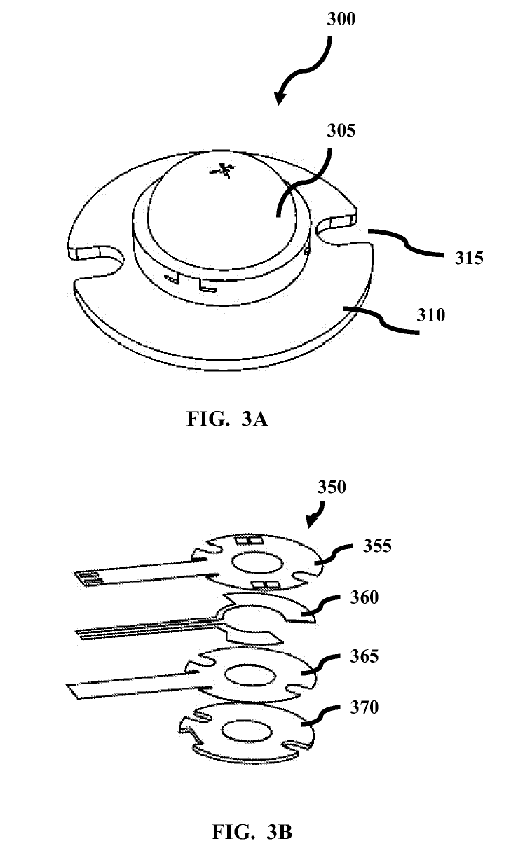

FIG. 3A depicts an exemplary LED arranged on a printed circuit board (PCB) assembly that may form part of a light engine in the lamp 100. A sub-assembly 300 includes an LED package 305 and a substrate 310. The substrate 310 may include driver circuitry and/or connections to a power source, for example, to form a light engine. In an illustrative example, the substrate 310 may include circuitry that may cooperate with the LED 305 to operate as a light engine. In some examples, the substrate 310 may provide substantial thermal conduction from the LED package 305 to a heat spreading element. In an illustrative example, the substrate 310 may include a metallic layer to provide substantially low thermal impedance to promote heat conduction. Some embodiments may implement the assembly 300 using a printed circuit board (PCB) with an aluminum backing as the substrate 310. The PCB may, for example, include metal (e.g., copper) area fills and or traces to make surface mount connection to terminals or heat conduction pads of the LED package. The metal fills may provide a substantially reflective surface to promote reflection of light in the light chamber toward the lens 125.

The depicted substrate 310 in this example includes a pair of cut-outs 315. In some examples, the cut-outs 315 may provide a channel to route electrical connections between the LED package 305 and a driver circuit and/or power source, for example. In some implementations the cut-outs 315 may receive fasteners (e.g., screws, clips, rivets) to mount the assembly 300 to the base 105.

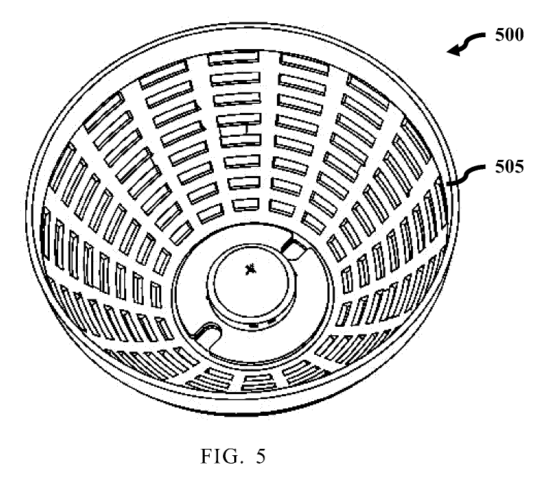

FIG. 3B shows an exemplary apparatus 350 to make thermal connection between a heat spreading element (not shown) and a bottom portion of the LED package. Examples of a heat spreading element in thermal communication with the exemplary apparatus 350 are described with reference to, for example, at least FIG. 5. Referring to FIG. 1, the depicted apparatus 350 may further make electrical connection between the LED package 305 and the terminals 110 in the base 105.

A flex circuit in this example provides electrical connection between the terminals 110 and electrical terminals of the LED package 305. The apparatus 350 includes a flex circuit formed by an insulative film 355 with a proximal set of contacts for making electrical connection to terminals of the LED package 305, a conductive layer 360 to provide electrical current paths from the proximal set of contacts to a distal set of contacts on the film 355, and a second insulating film 365 opposite the film 355. The distal set of contacts may make electrical interface to, for example, a driver circuit in the base 105, for example, or directly to a connector interface to the input terminals 110. The distal set of contacts may be inserted through a slot (not shown) in the substrate 310, which slot may be located between the cutouts 315 and along a peripheral region of the substrate 310.

In some embodiments, a portion of the flex circuit assembly (355-365) may be toroidal or other shape that defines an aperture under the LED package 305. The aperture receives a raised central portion of a metal slug 370, as shown in the depicted example, which may make substantial thermal contact or be in substantial thermal communication to a bottom surface of the LED package. Heat energy may transfer from the LED package to, for example, fastening hardware (e.g., screws, clips) that make direct contact with the metal slug. Heat energy may be transferred from the LED via the metal slug to a thermally conductive shell, as depicted in one embodiment in FIG. 5. The thermally conductive shell may serve to substantially spread heat energy as a heat sink for the LED.

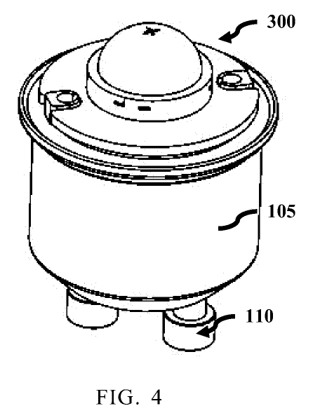

FIG. 4 depicts a partially assembled lamp, including the sub-assembly 300 installed in the base 105. Within the base 105, electrical connection may already be made between the LED package 305 and the terminals 110. In some embodiments, such as those of FIG. 3B, for example, assembly may not require soldering operations to make electrical connections between the LED package 305 and the pair of terminals 110.

FIG. 5 depicts an exemplary assembly 500 to provide thermally controlled operation of the LED lamp, for example, using a shell 505 formed into a generally parabolic shape. In some implementations, the shell 505 may be thermally conductive, anodized, and/or stamped metal (e.g., aluminum), for example. In some examples, the shell 505 has, as in the depicted example, a substantial number of perforations arranged in an array to permit airflow to the reflector. The apertures in the shell 505 are arranged to admit air flow from substantially any radial direction, which may promote convective flow in a wide range of orientations of the lamp (e.g., downlight, wall wash, horizontal orientations, etc. . . . ). The shell 505 may provide both substantially reduced thermal impedance, considering convective air flow to transfer heat independent of radial orientation of the lamp, which in turn may advantageously promote efficient performance as heat spreader to transfer heat away from LED.

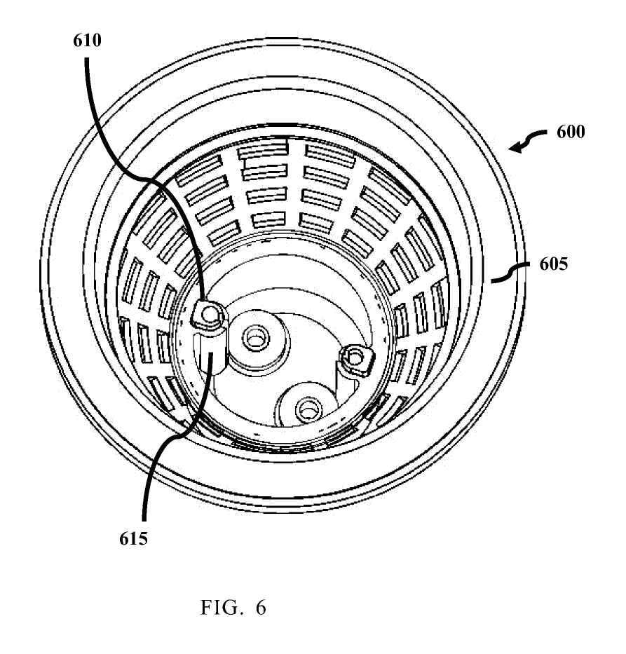

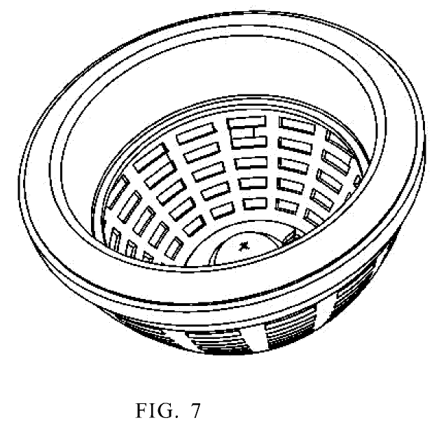

FIGS. 6-7 depict further assembly of the shell 505 coupled to a exemplary reflector 605 and the base 105. In an illustrative example, the reflector 605 may be adhesively-coupled to a distal end of the shell 505. In some other examples, the reflector 605 may include one or more snap features to engage and retain contact with the distal end of the shell 505. For purposes of explanation, the assembly 300 and lens are not shown to reveal further detail an interior volume of the base 105.

In the depicted assembly 600, the shell 505 includes a pair of mounting tabs 610 that are substantially coplanar and bent toward an interior volume of the shell 505. A corresponding pair of threaded cylinders 615 that are integral to the base 105 each have a threaded aperture in register with an aperture on the corresponding mounting tabs 610. In a complete example assembly, one or two screws may be inserted through cut-outs 315 in the substrate 310 and through the above-mentioned apertures in tabs 610 to engage threads in the cylinders 615. Thus, one or two screws may be used to securely assemble together the assembly 300, the base 105, and the shell 505 to form a light engine.

FIG. 7 shows a perspective view of an exemplary sub-assembly that includes the reflector 605, the shell 505, and the assembly 300 with the LED package 305.

FIG. 8 depicts an exemplary lens coupled to the assembly 300. As depicted, a lens 805 may be formed of a substantially transparent plastic or glass material having a substantially uniform index of refraction. In some implementations, the lens 805 may be formed with a gradient index of refraction (GRIN) lens that may form a desired beam pattern. The lens 805 may include features that provide substantial diffusion, which may advantageously yield a more uniform light distribution.

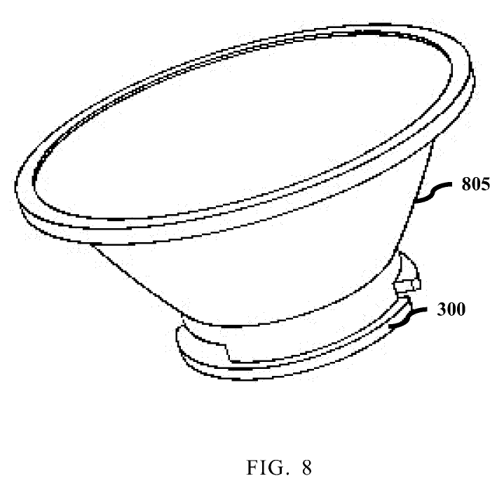

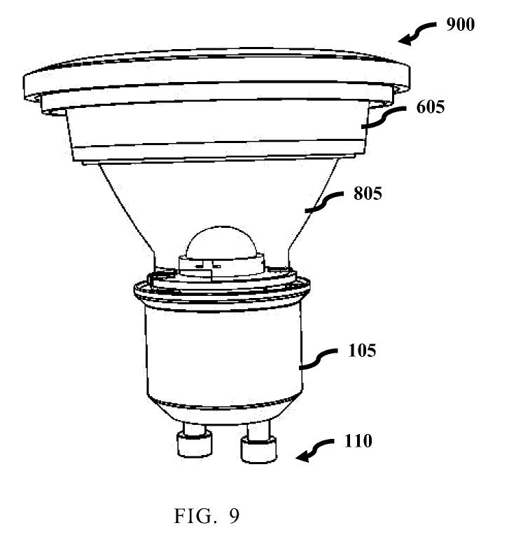

FIG. 9 shows a side elevation of an example sub-assembly that includes a reflector coupled to a transparent lens. A depicted assembly 900 includes the LED package 305 in the assembly 300, which is mounted to the base 105 having terminals 110. The reflector 605 provides a substantially reflective surface around and extending beyond a distal end of the lens 805. In some embodiments, the reflector 605 may help to generally redirect light near the distal end of the lens 805 out of the light chamber. To aid understanding, the shell 505 that generally provides a substantial heat sink is removed to reveal arrangement of the interior features.

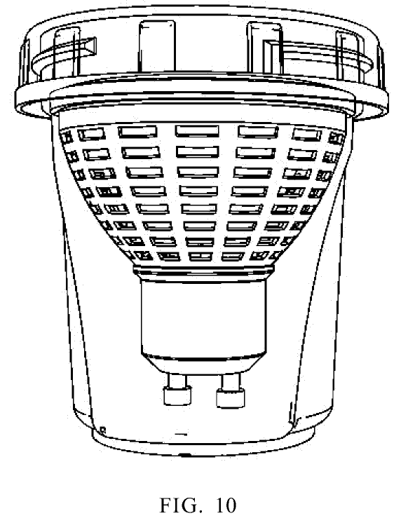

FIGS. 10-13 depict exemplary packaging and an LED lamp in GU 10 form factor arranged as a kit. In various examples, the kit may include a re-usable container with a lid, operable as a package for an energy efficient lamp. The container may be re-used for various applications after the lamp has been removed. In some examples, the package may be employed to protectively contain a used lamp for transport to a waste processing facility.

In an illustrative example, the package may house a mercury-free LED lamp during warehousing, distribution, and retail sale operations. For example, the containers containing the LED lamps may be stacked vertically on a retail shelf, permitting customers to view the LED lamp from all sides through the transparent container walls. The LED lamp may be removed from the container to replace a mercury-containing bulb, such as a fluorescent bulb, for example. To protect the mercury-containing bulb against breakage, the fluorescent bulb may be protectively stored in the container and sealed with the lid resealed until removed at a hazardous waste facility.

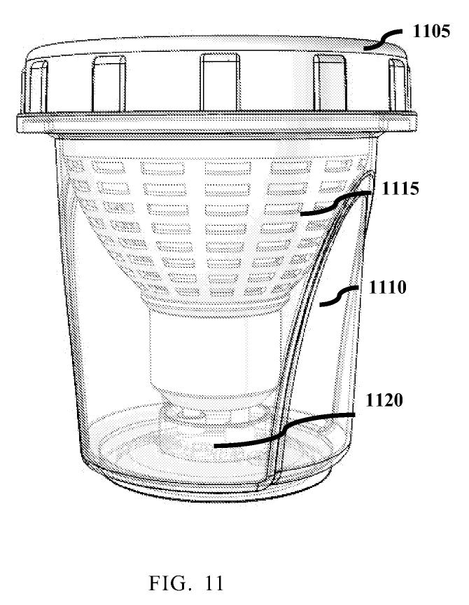

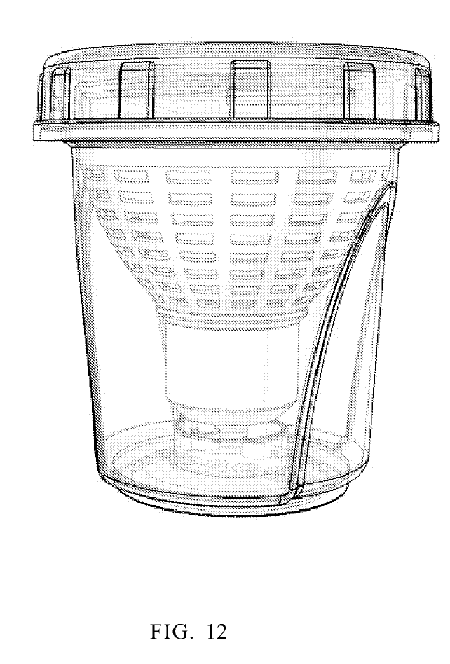

The kit includes an exemplary annular ring forming an integral bottom locating feature, which may may be seen from FIGS. 11-12. These locating features may substantially promote localization of the terminal posts 110, which extend from the base 105 of the LED lamp.

FIG. 11 depicts an exemplary kit with a transparent container body and opaque lid, showing a view of a locating feature on the bottom of the container. As depicted, a resealable lid 1105 is sealably engaged to a container body 1110. The container body 1110 and the lid 1105 cooperate to locate a lamp 1115. An orientation of the lamp 1115 is generally controlled, in part, by an annular ring locating feature 1120 that encircles a pair of terminals of the lamp 1115.

FIG. 12 shows an exemplary kit with a transparent container lid and transparent body. In this example, the lid 1105 reveals engagement among corresponding horizontally-oriented features to releasably secure the lid 1105 to the container body 1110.

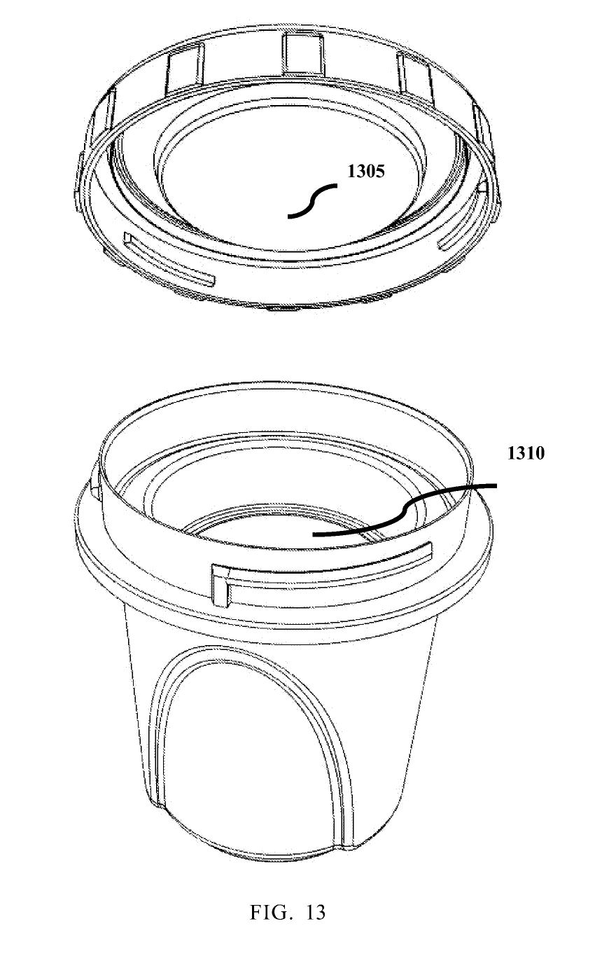

FIG. 13 depicts an exemplary kit with a lid ready to be assembled to the container body while containing a lamp. In a particular example, FIG. 13 shows an exemplary package with a top locating feature 1305 that forms a centrally-located partial sphere that extends downward from a bottom surface of the lid and toward a top surface of the LED lamp. As the lid is rotatably engaged to the container body to engage corresponding substantially horizontally-oriented features, a top locating feature 1305 is advanced to a position in substantial proximity to the top surface 1310 of the LED lamp. Engagement between the top locating feature 1305 and the top surface 1310 may cooperate with containment of the terminals by the bottom locating feature 1120 (as shown in FIG. 11) to substantially orient and center the lamp along a vertical central axis of the container body 1110.

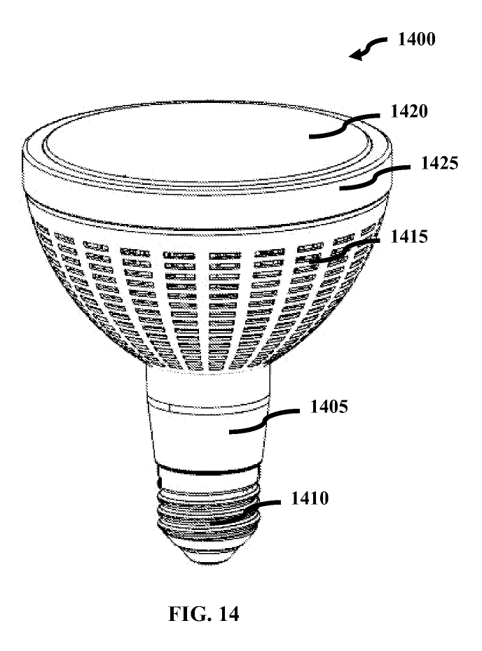

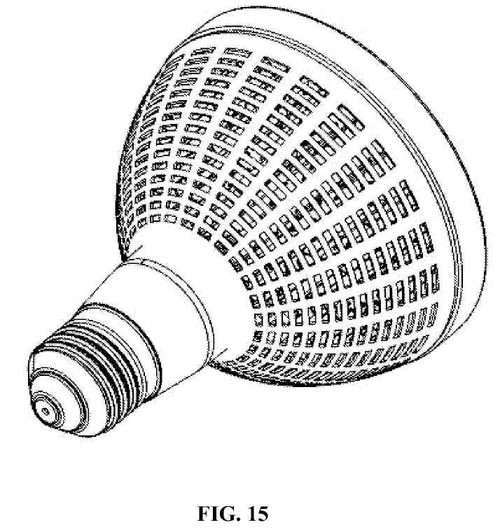

FIGS. 14-20 depict construction and arrangement of an exemplary LED lamp in a PAR 30 form factor. FIGS. 14-15 particularly show respective side and bottom perspective views of an exemplary lamp compatible with, for example, PAR 30 style lamp applications.

In the depicted example, a lamp 1400 includes a base 1405 coupled between an electrical interface 1410 and a body. The body includes a heat spreader 1415 that couples to the base 1405 and houses components of a light engine and a light chamber. The light engine generates light that is emitted through a lens 1420. In some The lens 1420 is secured to a distal end of the heat spreader 1415 by a securing ring 1425, which may be rotated, in some examples, to engage locking features on the heat spreader 1415, for example.

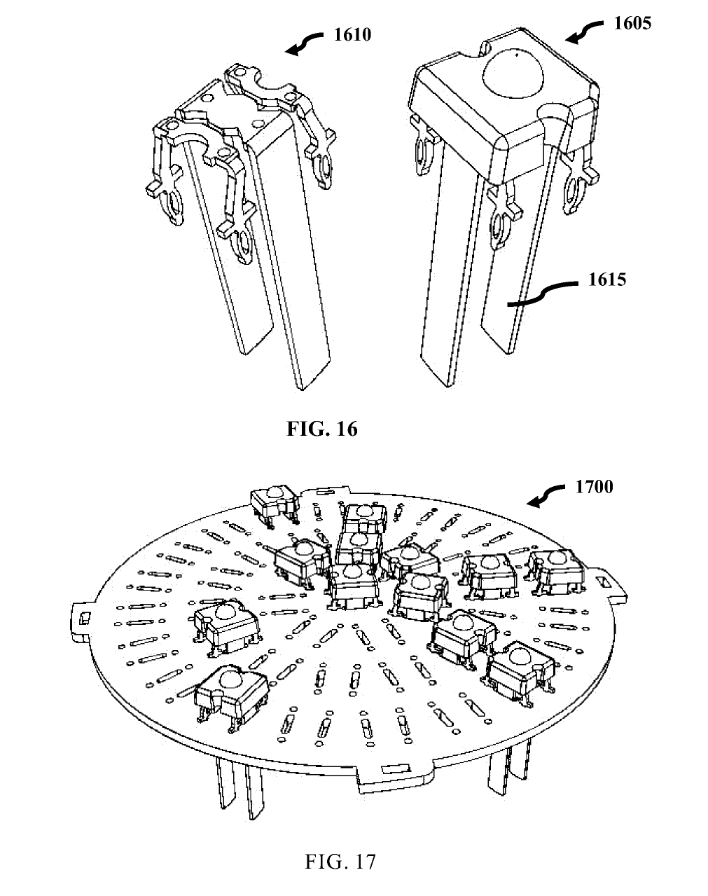

FIGS. 16-17 depict an exemplary light engine. In this example, an LED 1605 is mounted on a corresponding thermal spreading framework 1610. Extending away from the LED 1605 is a pair of thermal fins 1615 to provide reduced thermal impedance to ambient temperature.

In FIG. 17, an example light engine 1700 includes a number of the LED 1605, each with a thermal spreading framework 1610, distributed in an exemplary pattern across a PCB in a substantially circular and radial pattern. Each of the LEDs 1605 is arranged on a sub-assembly that includes thermally-conductive fins 1615 that extend below the PCB to provide thermal mass and surface area in the region below the PCB.

Embodiments of the exemplary LED engine arrangement on a PCB are described, for example, with reference to at least FIG. 6 of U.S. Provisional Patent Application Ser. No. 61/152,670, entitled “Light Emitting Diode Assembly and Methods,” which was filed by Grajcar, Z. on Feb. 13, 2009, and the entire disclosure of which is incorporated herein by reference.

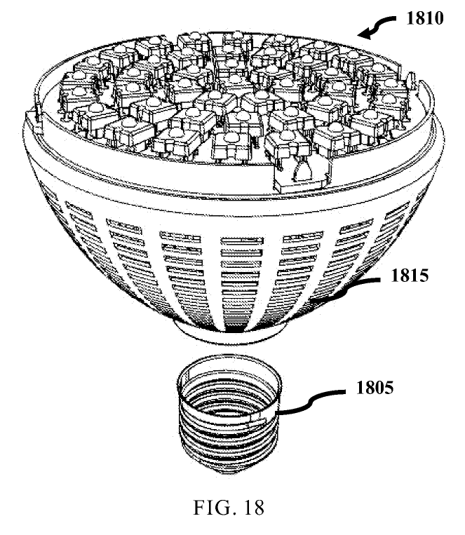

FIGS. 18-20 shows an exemplary electrical socket 1805 that receives electrical power to power the LEDs. In some examples, the socket 18 couples to the PCB via a wiring harness, flex circuit, or fastening hardware (e.g., screws).

FIG. 18 further shows an exemplary fully populated LED engine 1810 using the LEDs 1605. The perforated shell 1815 permits substantial airflow across or around the thermally conductive fins 1615 that extend below the PCB of the light engine 1810. The perforated shell 1815 may permit airflow that can support convective heat exchange with thermal fins 1615, for example, with the lamp oriented in substantially any direction. In some embodiments, the light engine 1810 may provide substantial thermal coupling to a thermally conductive perforated shell 1815 by thermally conductive paths. A base connecting the shell 1815 to the socket 1805 is not shown to more clearly illustrate the components described.

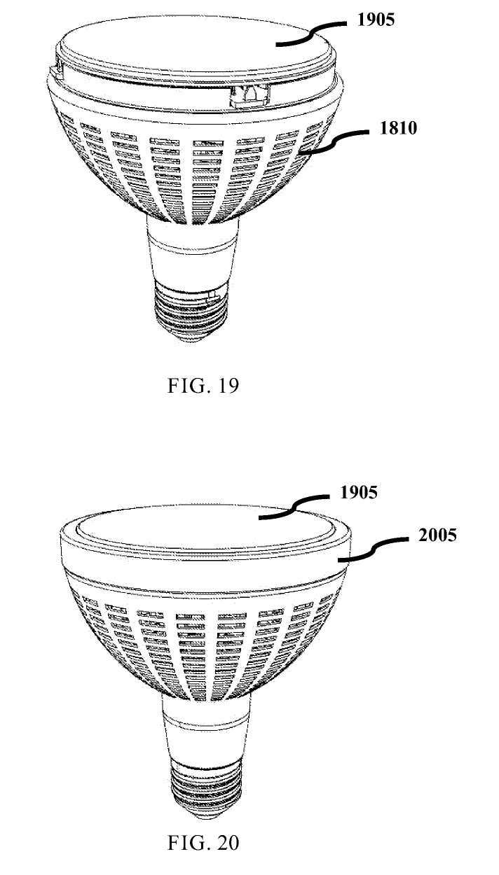

FIG. 19 shows an exemplary intermediate assembly step in which a lens 1905 is installed on a distal end of the shell 1810.

FIG. 20 shows an exemplary securing ring 2005 that may secure the lens 1905 to the lamp.

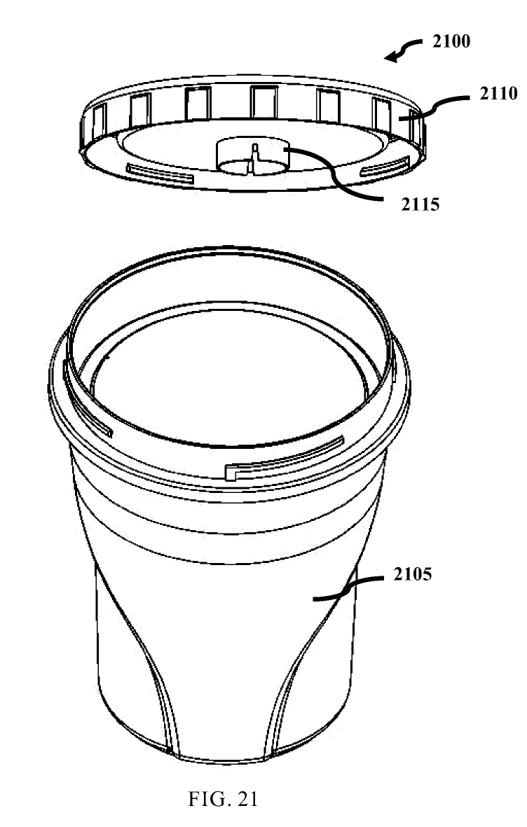

FIGS. 21-24 depict exemplary packaging and an LED lamp in PAR 30 form factor arranged as a kit.

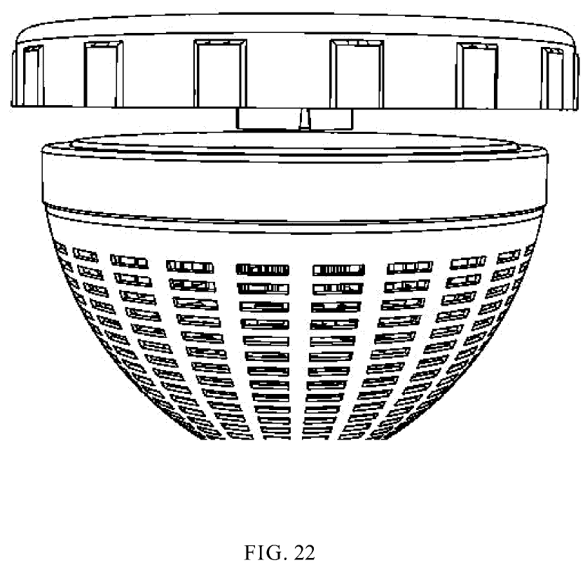

FIGS. 21-22 show an exemplary top locating feature on the bottom surface of the lid. In this example, a kit 2100 includes a container 2105, which may be sized for a PAR 30 style lamp, a lid 2110, and a top locating feature 2115. The locating feature 2115 may, for example, limit the vertical movement of the lamp within the package. This may advantageously prevent damage to the lamp during shipping or handling. In the depicted example, a circular feature extends downward from the bottom surface of the lid to contact or come in close proximity to a top surface (e.g., lens) of the PAR 30 lamp. The interface between the locating feature and the lamp may substantially protect the lamp from damage by distributing any vertical force of the lamp due to acceleration of the lamp toward the lid (e.g., when dropped from a shelf).

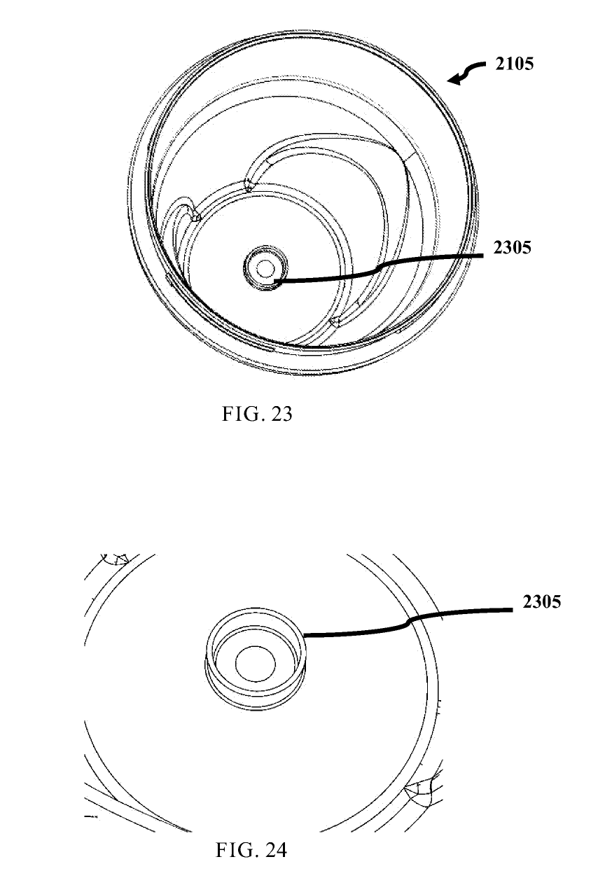

FIGS. 23-24 show an exemplary bottom locating feature that extends from the interior floor of the container. In this example, a container body 2105 includes a bottom locating feature 2305 configured to capture and locate at least a portion of the socket 1805 of a PAR 30 lamp, for example. The bottom locating feature 2305 may cooperate with the top locating feature 2115 and the side walls of the container body 2105 to substantially orient the lamp within the container body 2105, and prevent substantial misalignment of the lamp. Advantageously, the features of the package may cooperate to maintain the LED lamp in a substantially vertical orientation and in a fixed position within the package. Furthermore, the locating features may advantageously promote automated packaging by providing features that simplify making reliable, automated insertions of LED lamps into such packages.

Although various embodiments have been described with reference to the figures, other embodiments are possible. For example, various disclosed construction features or methods may be applied to lighting or optical apparatus other than LED lamps in the GU 10 or PAR 30 form factors.

In various examples, a kit may include a container with a re-closeable lid and an LED lamp. In some examples, a kit may further include a set of instructions or information packet mechanically coupled to the package or the lamp. The instructions may include information about how to properly operate the lamp. By way of example, the instructions may include specifications for input power (e.g., voltage, current, or frequency), output power or intensity, lamp temperature specifications, and/or compatible fixtures for receiving the lamp.

Some embodiments may be constructed with a lid with a centrally recessed top surface region sized to stack with at least one similar package. For example, transparent containers may be stacked at least 5, 6, 7, 8, 9, or at least about 10 containers high to display LED lamps from any direction. Accordingly, the orientation of the package may be in any direction without obscuring the view of the lamp contained therein.

In various examples, at least a body of the container is partially or completely transparent to permit visual display of the LED lamp from any direction, including a full 360 degrees in a horizontal plane. In some examples, the lid of the package may further be transparent to permit inspection from the top of the package.

In some embodiments, implementations may be integrated with other elements, such as packaging and/or thermal management hardware. Examples of other elements that may be advantageously integrated with the embodiments described herein are described with reference, for example, to FIG. 15 in U.S. Publ. Application 2009/0185373 A1, filed by Z. Grajcar on Nov. 19, 2008, the entire contents of which are incorporated herein by reference.

In some examples, a top locating feature of the package may be formed from polypropylene or other suitably soft material for compression against the top of the lamp without scratching or scuffing the lens.

To facilitate vertical stacking of multiple container housings in some embodiments, a top exterior surface of the lids may be formed with at least an annular horizontally flat surface sized and shaped to receive and to register a corresponding annular projection on a bottom exterior surface of a container housing. The lid may include an annular ring that defines a central pocket to receive a bottom portion of the container body that is stacked on top of that lid. In some examples, a circumference of the bottom of the container housing must be at least less than an inner diameter of the upper surface of the lid.

In various embodiments, the packaging container may be substantially made from biodegradable materials. For example, the packaging may be made from corn starch-based materials. Some examples may include additives to the plastic to promote biodegradability. Examples of suitable materials may include ECOPURE (trademark) commercially available from Bio-Tec Environmental of Winmalee, Australia.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are contemplated.

What is claimed is:

1. A re-usable package system for a lamp, the system comprising:
an electric-type lamp;
a lid adapted to be removably coupled to a container body; and,
a container body with an aperture on one end, the aperture being sized and configured to receive the lamp, wherein the container body and the lid cooperate to register and retain the lamp in a substantially fixed orientation within the container body when the lid is secured to the container body.

2. The system of claim 1, wherein the lid comprises a top locating feature that extends from an interior surface on the lid to determine a substantially fixed vertical position of the lamp within the container body when the lid is secured to the container body.

3. The system of claim 1, further comprising a bottom locating feature that extends from an interior surface on the bottom wall of the container body to determine a position of an electrical terminal of the lamp.

4. The system of claim 1, wherein the container body comprises a substantially transparent material to facilitate visual inspection of the lamp contained therein while the lid is secured to the container body.

5. The system of claim 1, wherein the lid comprises an exterior surface formed with an annular channel to register a corresponding annular feature on a bottom exterior surface of the lid such that a plurality of the systems may be vertically stacked.

6. The system of claim 1, further comprising an additive to promote accelerated biodegradation of the container.

7. The system of claim 1, wherein the electric-type lamp comprises a light emitting diode (LED) lamp that illuminates in response to electric stimulation.

8. The system of claim 7, wherein the electric stimulation comprises a substantially sinusoidal voltage waveform.

9. The system of claim 1, wherein the electric-type lamp comprises a lamp having a GU 10 form factor.

10. The system of claim 1, wherein the electric-type lamp comprises a lamp having a PAR 30 form factor.

11. A kit comprising:
a lamp;
a lid; and,
a container body adapted for repeated coupling to and removal from the lid and configured to securely contain the lamp in a substantially fixed position within the container body when the lid is secured to the container body.

12. The kit of claim 11, further comprising a set of written instructions for operating the lamp by connection to an electric power source.

13. The kit of claim 11, further comprising a set of written instructions to re-use the container after the lamp has been removed.

14. The kit of claim 11, wherein the kit further comprises a top locating feature that extends from an interior surface on the lid to determine a substantially fixed vertical position of the lamp within the container body when the lid is secured to the container body.

15. The kit of claim 11, further comprising a bottom locating feature that extends from an interior surface on the bottom wall of the container body to determine a position of an electrical terminal of the lamp.

16. The kit of claim 11, wherein the container body comprises a substantially transparent material to facilitate visual inspection of the lamp contained therein without removing the lid from the container body.

17. The kit of claim 11, wherein the lid comprises an exterior surface formed with an annular channel to register a corresponding annular projection on a bottom exterior surface of the lid such that a plurality of the systems may be vertically stacked.

18. A method of recycling a light package container, the method comprising:
providing a lamp;
providing a lid;
providing a container body that includes an open end and a bottom locating feature projecting toward an interior of the container from a bottom interior surface of the container;
positioning a terminal of the lamp in registration with the bottom locating feature; and,
fixing an orientation of the lamp within the container body by securing the lid to the open end of the container body.

19. The method of claim 18, wherein securing the lid to the open end of the container body comprises rotating the lid with respect to the container body to engage substantially horizontal surfaces on the lid with substantially horizontal surfaces of the container body.

20. The method of claim 18, further comprising:
removing the provided lamp from the container;
replacing the provided lamp with a lamp containing mercury;
securing the lid to the container body to protect the lamp containing mercury until the container is delivered to a hazardous waste collection facility.
